(19) United States
(12) Patent Application Publication
(10) Pub. No.: US 2013/0226821 A1
(43) Pub. Date: Aug. 29, 2013

(54) METHOD & APPARTUS FOR IMPROVING THE SKILLSET OF A SALES CANDIDATE BY USING SALES COACHING APPLICATIONS COUPLED TO E-LEARNING TOOLS

(71) Applicant: Callidus Software Incorporated, (US)

(72) Inventors: Richard Chetwynd, Walnut Creek, CA (US); Stephen Potts, Libertyville, IL (US); Leslie Stretch, Danville, CA (US)

(73) Assignee: Callidus Software Incorporated, Pleasanton, CA (US)

(21) Appl. No.: 13/758,785

(22) Filed: Feb. 4, 2013

Related U.S. Application Data
(60) Provisional application No. 61/594,981, filed on Feb. 3, 2012.

(51) Int. Cl. G06Q 50/20

(52) U.S. Cl. CPC G06Q 50/2057; G06Q 10/06398
USPC 705/328

(57) ABSTRACT

A method and apparatus is disclosed to improve a set of tasks performed by a salesperson. In some embodiments, a method comprises of receiving information about competencies being performed by a salesperson in order to complete a sales transaction, wherein each of the competencies associated with a salesperson is given a quantitative value. In some embodiments, the method comprises of identifying tasks being performed by the salesperson to support said competencies and assigning an individual value to said tasks in a manner to affect the quantitative value of the competencies. In some embodiments, a method for generating revenue by hyperlinking the tasks performed by a salesperson to e-learning courses is disclosed. In some embodiments, a method comprising of determining and assigning an e-learning course for a salesperson, and negotiating billing and revenue sharing plans is disclosed.

### CROSS-REFERENCE TO RELATED APPLICATION

This application claims the benefit of provisional Patent Application Ser. No. 61/594,981, filed Feb. 3, 2012, said application is assigned to the assignee of the present application, and incorporated herein by reference.

### FIELD OF THE INVENTION

The present invention is directed to the ongoing monitoring and assessing of a sales candidate by using a sales assessment application integrated with online e-learning tools in a manner as to constantly provide feedback and the evaluation of salesperson.

### BACKGROUND OF THE INVENTION

There is a constant need for a salesperson to improve in the execution of sales transactions in an organization. Generally, such improvements are measured only in the number of sales transactions being completed but there are host of other attributes that are necessary to show such improvement resulting in the completion of sales transactions; more precisely related to foundational skills in process of making a transaction. However, the related art is not focused on such attributes but on the initial stage of initially evaluating a candidate and the candidate's resume and then on the sales quota that the sales candidate has achieved.

Further, it is common that many resources in an organization are allocated to the initial hiring and training of a salesperson including multiple different kinds of evaluations as well as time spent by members of the sales organization for interviewing and comparing sales talent to make the right selection. During this initial process much information is generated and evaluations are made of a salesperson candidate including evaluations of his/her ability to do various kinds of selling whether it is door-to-door sales, cold calls, product demonstrations, presentations and industry contacts.

However, after the initial hiring and training processes the information gathered by the organization during the initial selection process is almost always discarded and not used in the ongoing assessment and training of a salesperson. Hence, an organization may spend significant time, energy, and resources showing in initial phase of recruitment, hiring, and evaluation, but fails to capture in the right form and properly capitalize such initial information and hence is unable to recognize the fruitful benefits that may result from being able to properly use such information on an individual basis to improve a salesperson's performance in the daily test upon hiring with his/her assigned work tasks.

There is a need for software applications methodology to provide ongoing monitoring and learning functionality so as to enable a salesperson to improve in the performance of their position by using the initially captured information. For example, with early onset identification of skilled set deficiencies and enhanced online learning tools there is a need for applications to use such resources in a manner to educate and pick up efficiency to compensate for the deficiencies in a salesperson's routine actions enabling them to improve in their overall performance.

In an organization, since there are multiple salespersons in a group selling different products and having a host of different attributes which can be grouped in categories such as strengths and weaknesses, and there is a need to keep track of the salesperson's individual attributes determining ways to better distribute those attributes of strengths versus weaknesses.

Many organizations do not have sufficient resources to allocate to functions such as tracking an ongoing monitoring and assessing of salespersons, and rely on human interaction to perform such functions. However, with necessary multitasking occurring today and salespersons located in multiple different locations it is difficult to humanly track and store such information and monitor consistently salespersons for deficiencies during the sales tasks. Further, salespersons have limited time as much of their time is allocated to meeting with potential customers and explaining products to the customers. However because of the limited time there are no real-time abilities to monitor, assess, and coach salespeople in the field.

Further, many corporations have a sales Academy or one-time training sessions but such training sessions do not take the place of ongoing monitoring application of skills and there is a need for additional tools which are available to heads of sales organizations for such ongoing monitoring and assessment of salespersons.

### BRIEF SUMMARY OF THE INVENTION

The present invention is directed to a set of tasks performed by a salesperson, which comprises the steps of receiving information about competencies being performed by a salesperson in order to complete a sales transaction wherein each of the competencies associated with the salesperson being given a quantitative value and identifying using an assessment application those tasks being performed by the salesperson to support said competencies and assigning an individual value to said tasks in a manner to affect the quantitative value of the competencies.

Also, the present invention uses an assessment application to analyze the competencies grouping the competencies into categories needing and not needing improvement, and then generating suggestion requests to said salesperson wherein said suggestion requests being hyperlinks to e-learning tools assigned quantitative values by the assessment application to affect the quantitative value of the competencies depending on a result of completion or not completion of said suggestion requests.

The present invention is also directed to a way of generating revenue by hyperlinking the tasks performed by a salesperson to e-learning courses, comprising the steps of initially determining using a sales coaching application an e-learning course for a salesperson to enhance a skillset of a salesperson in the performance of a sales transaction, and assigning using an assignment application coupled to the sales coaching application an e-learning course to a salesperson wherein the assigned course being part of the a list of courses pre-hyperlinked to a skillset associated with the completion of a sales transaction; and negotiating with third-party providers of the courses to generate billing and revenue sharing plans coupled to the sales coaching application to enable direct billing and revenue generation of the assigned e-learning courses by the coaching application.

Referenced throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in another embodiment,” and similar language throughout this specification may, but do not necessarily, all refer to the same embodiment.

Also referenced throughout this specification are the terms and/or phrases “for example,” “for instance,” “say,” “the like,” “etc.,” or similar language which generally means that the language, description, and explanation utilized is association is merely to demonstrate an element, feature, item, list of items, purpose, way, means, method, and/or the like for what has been described in association, but depending on the usage and situation, it may not be meant to be exhaustive representation or demonstration, or meant to limit the invention to that particular precise formation. Many modifications and variations will be apparent to the practitioner skilled in the art.

### BRIEF DESCRIPTION OF THE DRAWINGS

FIG. 1 is a diagram showing an assessment application coupled to an analytics diagram of an exemplary embodiment of the present invention,

FIG. 2 is a diagram showing an assignment application of an exceptional array embodiment of the present invention.

FIG. 3 is a diagram showing a suggestion requests application of an exemplary embodiment of the present invention.

FIG. 4 is a diagram showing an assignment tree hierarchical application of an exemplary embodiment of the present invention.

FIG. 5 is a diagram showing a symbiotic feedback flow of applications of an exemplary embodiment of the present invention.

FIG. 6 depicts a screenshot of the linking of the assignments to the coaching competencies identified in an exemplary embodiment of the present invention.

FIG. 7 illustrates how a user may select a course from a plurality of course offerings made available in an exemplary embodiment of the present invention.

FIG. 8 illustrates a screenshot of a hyperlinked course to the coaching system in an exemplary embodiment of the present invention.

FIG. 9 illustrates a screenshot of a notification that an administrator would receive in an exemplary embodiment of the present invention.

### DETAILED DESCRIPTION OF THE INVENTION

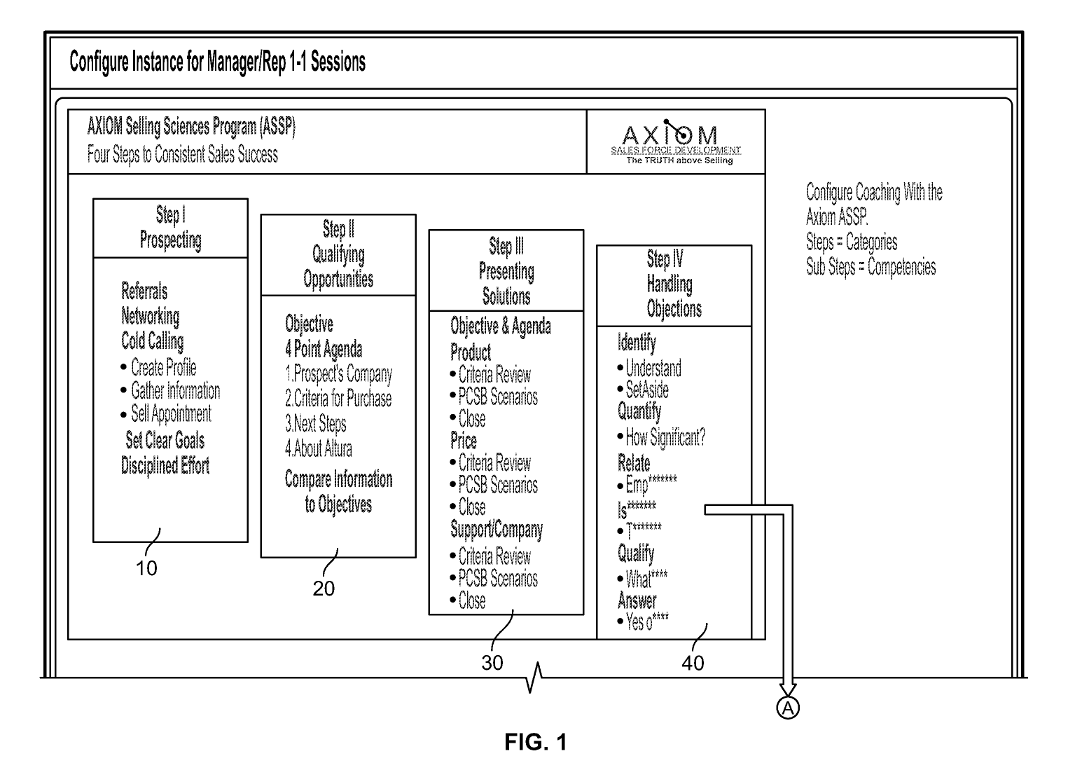

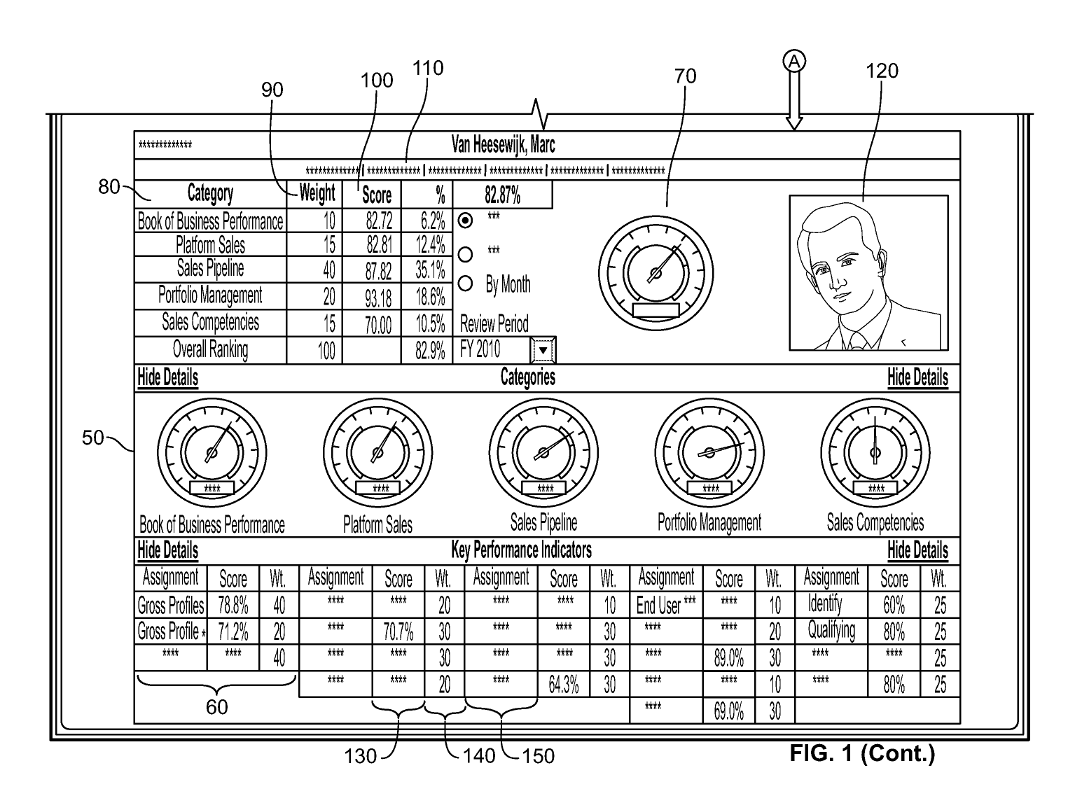

The present invention is directed to a method and system that monitors and assesses and provides feedback about performance in instances and ongoing performance in real-time of a salesperson in the course of his normal sales activities and transactions. With reference to FIG. 1, a series of steps is first performed to initialize and configure the sales assessment application. For example in step 10, the prospecting step contains the tests of referrals, networking, and cold calling which involve creating profiles, gathering information, and setting up appointments. Essentially step 10 sets forth the clear goals necessary to put forth a disciplined effort and provides the foundational knowledge base that the salesperson has to perform the goals that he has been hired to perform.

Step 20 qualifies the opportunities generally putting a multi-point agenda in which the points number may be increased or decreased depending on the type of transaction contemplated. The initial step 10 where the baseline information is then compared to the qualifying opportunities as pointed out in step 20. These qualified opportunities would for example include the prospects of the company, the criteria necessary from making a purchase, the steps involved in order for a purchase to happen, and information gathered all assemblages about the purchasing entity.

In Step 30 of FIG. 1 there is presenting the solutions; for example such solutions could include: the objects and agenda of the product which involve looking at the criteria, various pricing model structures, the pricing necessary in order to close the transaction, and the necessary ongoing support input and possible other scenarios that may occur during this closing process step 30. Additionally in step 40 handling objectives are being performed for example these include identifying what it means to understand this or set aside the proposal, quantifying which means to recognize how significant the proposal is, and a host of other criteria such as relating to. Also, there is added information such as other proposals making quality judgments, and answering any additional questions that may come up. Hence, the initial steps to 10, 20, 30 and 40 set forth the necessary steps to lay the foundation and enable consistent sales success. The information is gathered in these four steps 10, 20, 30 and 40 is then further characterized 80, weighted 90, scored 100, associated with an individual profile 110, visual metrics generated therefrom 70, and additional individual profile information generated 120. Also in the configuration steps additional visual analytics indicators are added 50, subsequent assignment information 60, scoring of this information on 30, weighting applied to the scoring factors, and additional assignment information added 150.

Hence, steps 80 to 150 lay out the configuration in an application GUI all the non-quantitative information gathered in steps 10, 20, 30, and 40 in a one-page easy to view visual HTML formatted page. Further, as an example is set forth in FIG. 1 the aggregated portal page includes in a fixed format a category listing of the sales function tests. As noted in FIG. 1, the categories that are laid out here are quotes “book of business . . . ”; “platform sales”; “sales pipeline”; “portfolio management”; “sales competencies”; with the reciprocal weighting amounts of 10, 15, 40, 20, 15 all adding up to the composite score of 100. Each of the category functions is for the scored on a percentage basis for example the book of business is given a score of 62.12 or 6.4%, the platform of sales is given a score of 82.61 or a 12.4%; the portfolio management is given a score of 93.18 or 18.6%. The sales competencies are given a score of 70.00 or 10.5% and this is designated for the fiscal year 2010. An average score is computed of 82.87% as noted this court that identifies deficiencies such as in the sales competencies which is given a lower score as well as the book of business which is given a lower score compared to the sales pipeline, platform sales and portfolio management which are all being given higher scores. Hence the portal is able to visually represent on the year to date manner using weighted coefficients scores percentage of scores and 80 weighted average of scores. Additionally as noted in the portal the use of the designated year to date, quarter to date, or by month. Additionally analytic 72 is a real-time cell configuration representation of the percentage score in this case of 84.42%.

In the lower part of the portal in FIG. 1, there is shown the assignment 60 which is sub-categorization of the book of business performance which is shown in the analytic dial 50. As an example the book of business/performance is composed of gross profits, cross profit margins, and open KPI. The subsequent weighting of the score gives an average with score of 82.73% for the perform book of business performance. Likewise for the platform sales analytic dial 50 is comprised of assignment details of various data including shore protection, investor gross sales, exposed etc. giving an aggregated composite score of 82.61%. Additionally sales pipeline, portfolio management, and sales competencies are each given detailed assignment information shown in the FIG. 1. Hence, if assignment information is added and scores are calibrated for each of the category areas or in some instances may simply be one category area because the ported is navigation of all the categories even a minute change in one category area would result in a change in the overall aggregate comp us score. Hence the portal provides changes in the subset competencies which are dynamically coupled to each of the categories using for example an additive or subtractive algorithmic solution, found in Microsoft Excel® or other like spreadsheet applications.

Category value=sum([competence value [1 . . . N]*weights [1 . . . N])/100 Equation 1.1

Total score=sum([category values [1 . . . N]*weights [1 . . . N])/100 Equation 1.2

As indicated in Equation 1.1 the category values are the sum of the competency values or the sub-steps of the assignments which are aggregated to sum the assignment values multiplied by a weighting factor and a percentage amount. The total score is then likewise a sum of the weighted category values multiplied by percentage amount. Hence, each of the competency values affects the overall category and vice versa the overall total score.

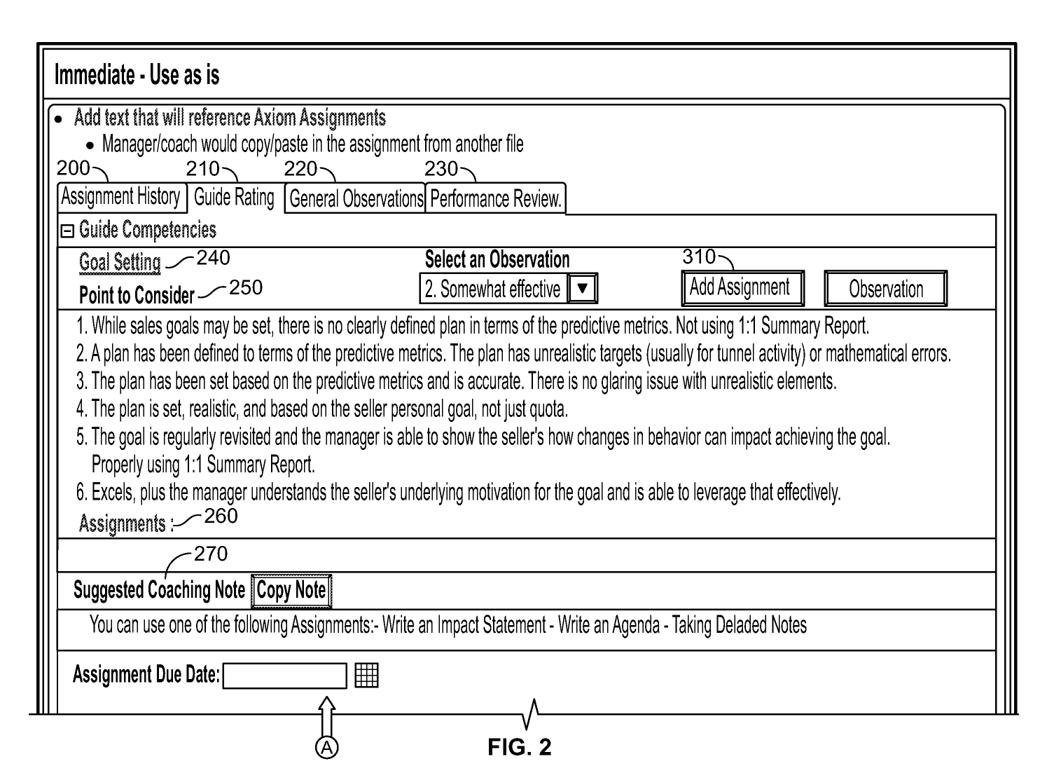

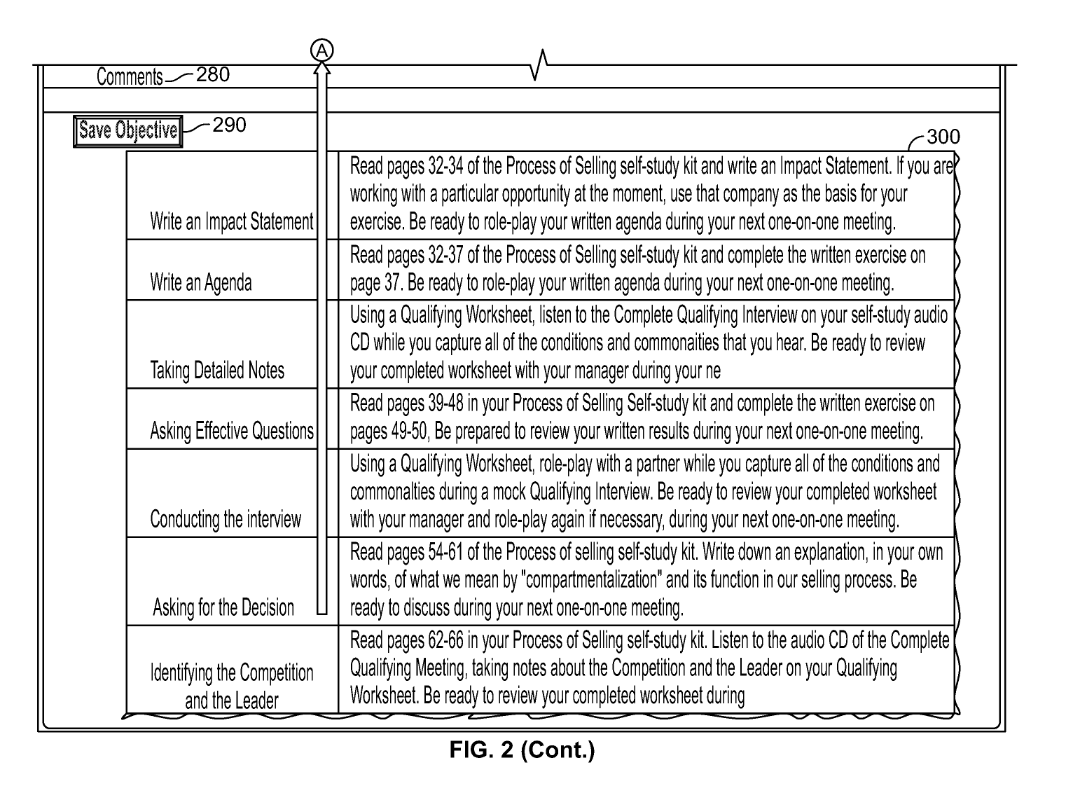

FIG. 2 is a screenshot diagram of the coaching assignment sent to a salesperson here in e-mail tools such as Microsoft Outlook®; Yahoo Hotmail®, Google g-mail® or the like. The assignment e-mail is sent in response to whether the performance indicator in a particular assignment area is above or below a preset threshold. The assignment screenshot is automatically generated on a pre-determined basis which could be daily, weekly, or in real-time after a transaction being monitored has a material effect on the total score or a category score. Further additional event segments can be added to generate the screenshot diagram depending on the particular tasks assigned to the salesperson or the business climate warranting such assignments to be sent out.

FIG. 2 includes the assignment history 200, tied to the readings 10, general observations to 20 and performance review 230. Additionally in the guide competencies additional information such as goal setting 240, points to consider 250 which may include many as suggestion points; some examples have been noted in the diagram here in. For example as noted herein these points would include sales goals that may be set, the plans predictive metrics, whether the plan is realistic and based on the sales first is a personal goal not just a quota, the goals being readily visited and the manager is able to show the seller how changes in behavior can impact achieving the goal, the manager understands the severs underlying motivations for the goal; these are simply examples of potential points to consider and many variations of these points will obviously be used depending on circumstances.

Additionally, assignments 260, coaching suggestion note 270 are also in the present screenshot e-mail assignment in hyperlink to another window or pop-up screen which would include multiple different kinds of suggested coaching notes. In FIG. 2, there is shown several of such pre-program notes which the administrator could use and include such as taking detailed notes, ask effective questions etc.

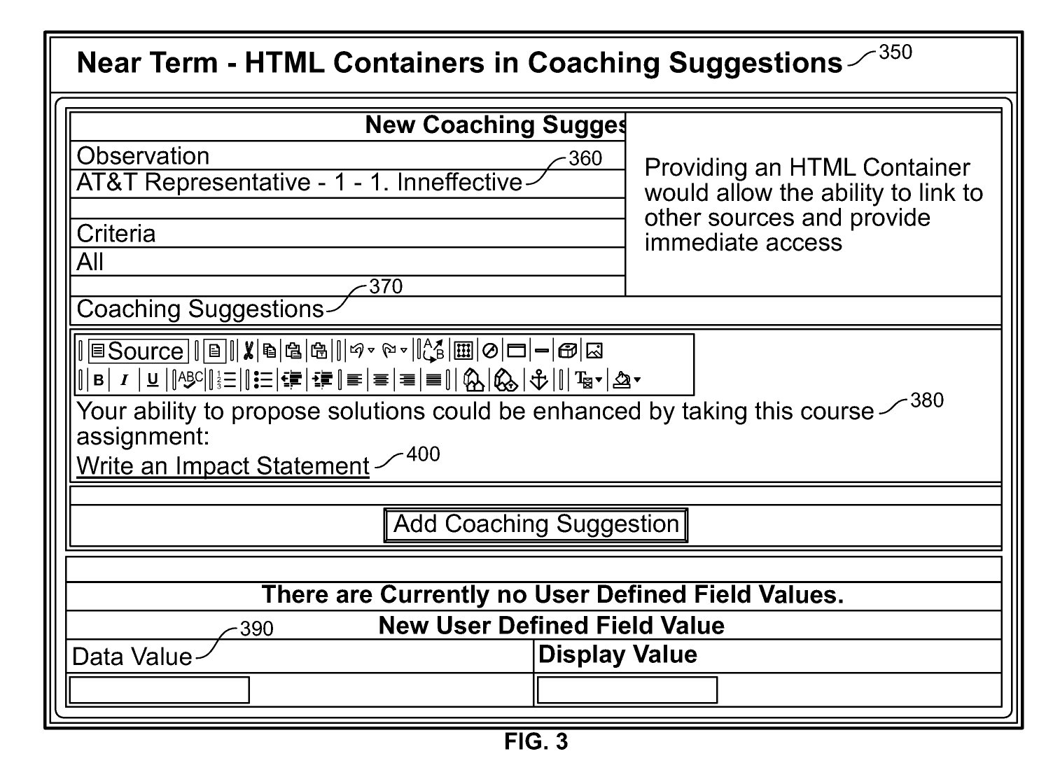

FIG. 3 shows an HTML screenshot containing a coaching suggestion which includes briefly observations 360, coaching suggestions 370, particular written out suggestions 380 (this case is suggestion is your ability to produce solutions be enhanced by taking this course assignment), write an impact statement 400 and finally data values 390. This is simply an exemplary HTML version of a coaching suggestion utilizing modules integrated. HTML script where each of the modules is called in to get the aggregated value in a screenshot entitled new coaching suggestions.

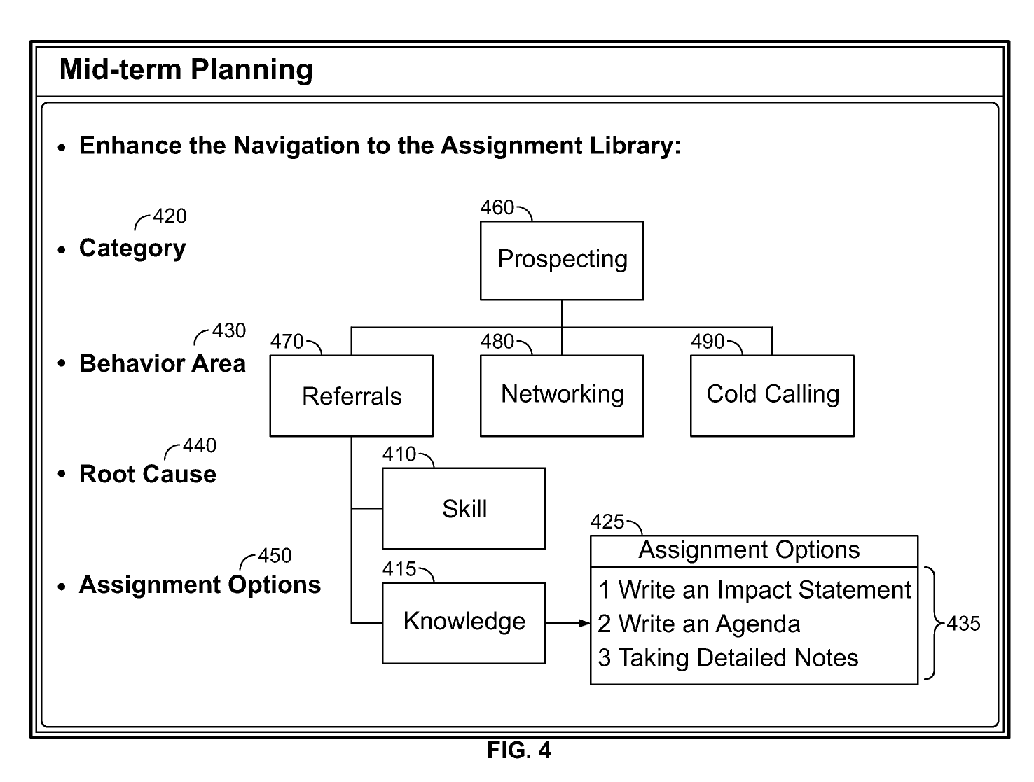

FIG. 4 shows the navigation of the assignment library from the initial categories 420 then the behavior area 430 then root cause 440 and finally the family assignment options 450. As an example, a category is designated prospecting 460, coupled to three behavioral areas which are referrals 470, networking 480, and cold calling 490. In order to support these three behavioral areas additional root causes and assignment information to are coupled therein. For example to support referrals 470 as a behavior of a salesperson, it is necessary to have certain skills 410 and also to have a certain foundational knowledge of potential perspective sources of referrals 415. Like any knowledge database such knowledge databases usually created by activities in this case these activities are quantified by assignment options 425 which include assignment options which are generated by the administrator 435. Hence this navigational assignment library enables a salesperson to view particular behavioral areas look at the root causes and assignment options which will better the eventual categories. That is, the assignment options are building blocks to the knowledge and the knowledge and skill of building blocks to the referrals and the referrals and other baby behavioral areas of building blocks to the prospecting or category 420. Hence this assignment library provides a way of enabling simple tasks to be characterized to each root cause 440 which builds the behavioral areas 430 which supports the categories 420.

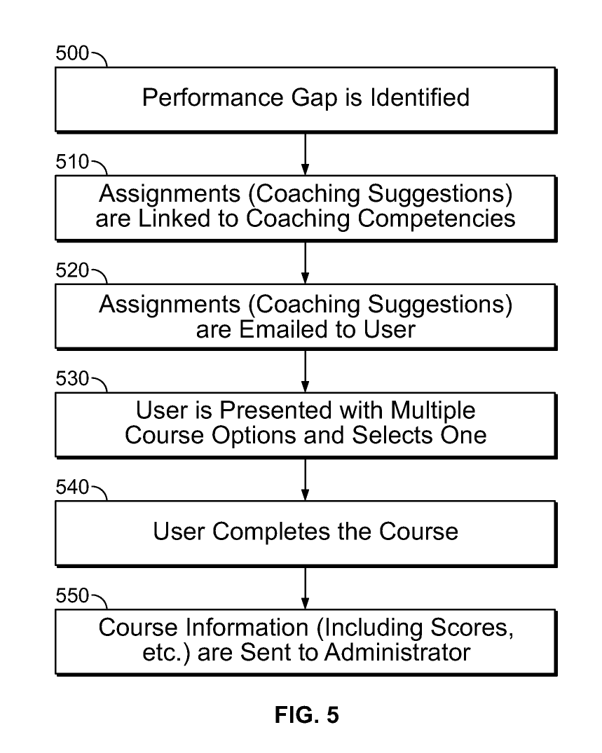

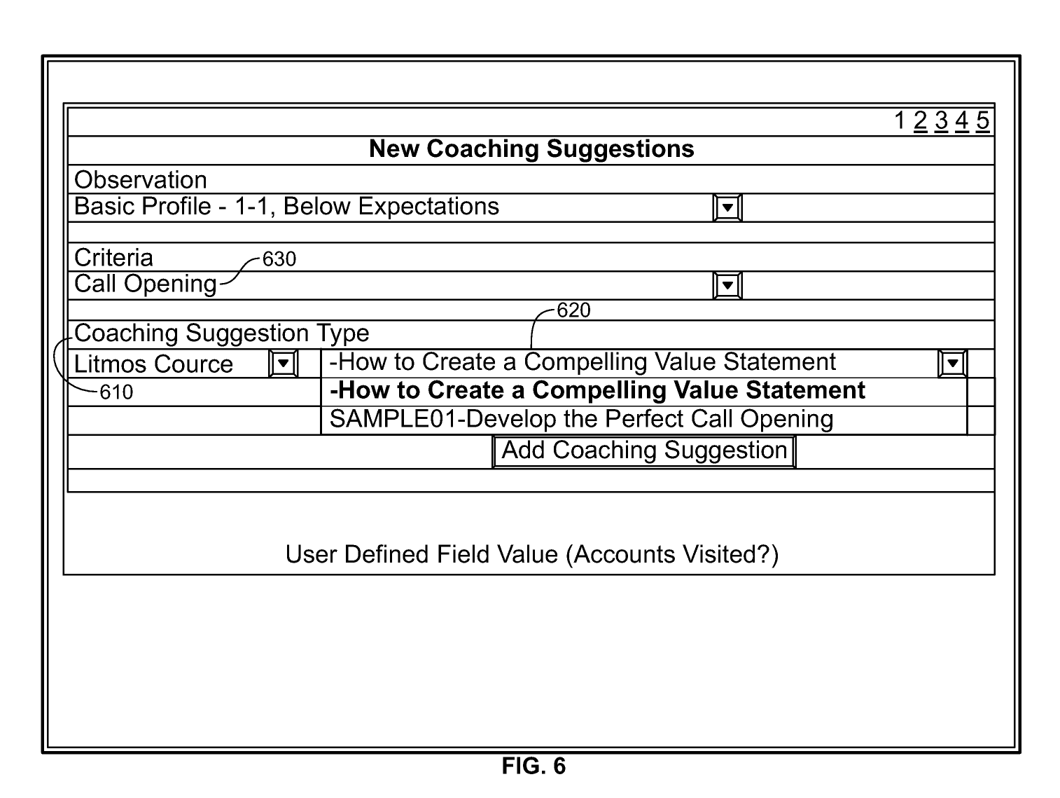

FIG. 5 depicts the sequence of steps that occur in a coaching cycle. Beginning with step 500, a performance gap is identified and based upon any deficiencies present. In step 510, assignments (based on the deficiencies of step 500) are linked to coaching competencies. In step 520, assignments are emailed to the user. As shown in FIG. 6, there would be a course description about the course which would explain the course objectives, information about the usefulness of the course, and would perhaps include review information about the course, as well as information about how the course has benefited others in the past who have also sought to improve upon the particular skill set identified. Further, the hyperlinks to the course assignment would include completion of the course, any perhaps include an evaluation of the course.

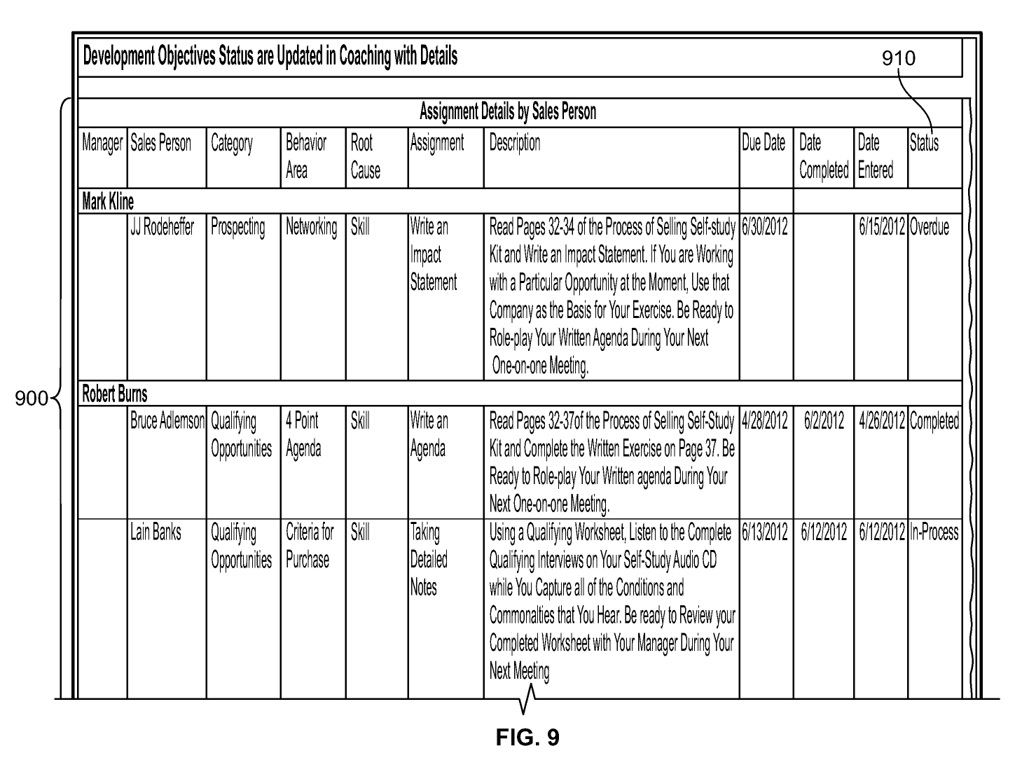

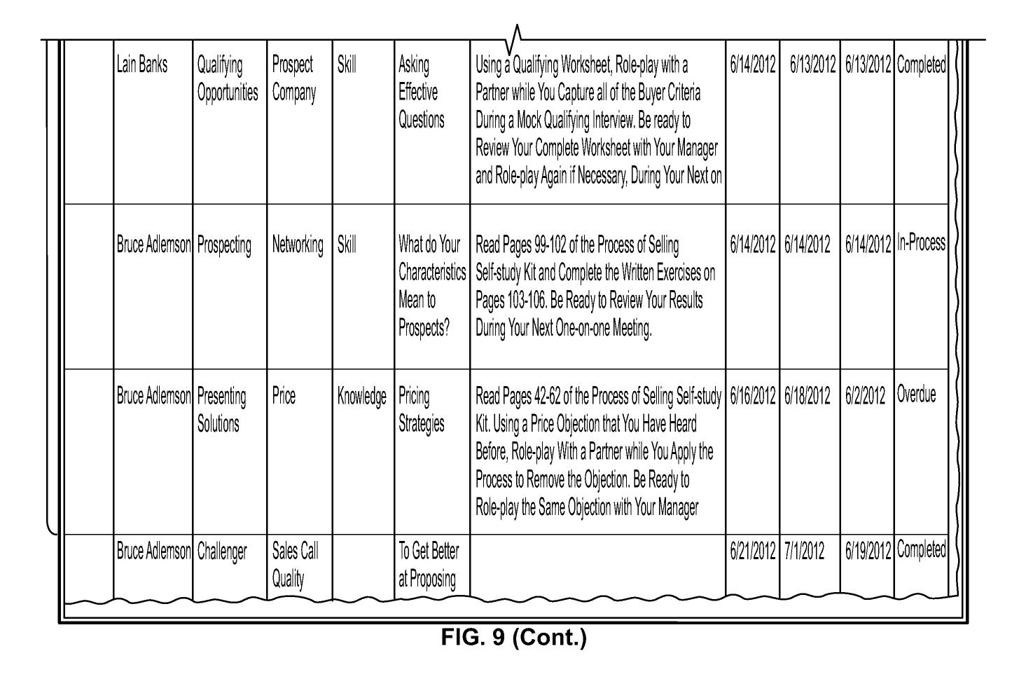

In step 530, a user is presented with multiple course options and is able to select the intended course for completion. In step 540, the user completes the course. Upon completion of the course, a notification will be sent back to the coaching application or to an administrator as outlined in step 550. As shown in FIG. 9, the notification may include information such as the status 910 of the course (not yet completed/in progress/completed, etc.) plus any additional information gained in the completion of the course which is also reflected in the assignment details 900.

FIG. 6 illustrates the linking of the assignments (coaching suggestions) to the coaching competencies identified. A user may select a type of coaching suggestion 610. When “Litmos Course” is selected, a list of potential courses are presented in the pull-down menu 620. The criteria 630 enables a user to select different courses which may be defined based on the score or assessment previously received.

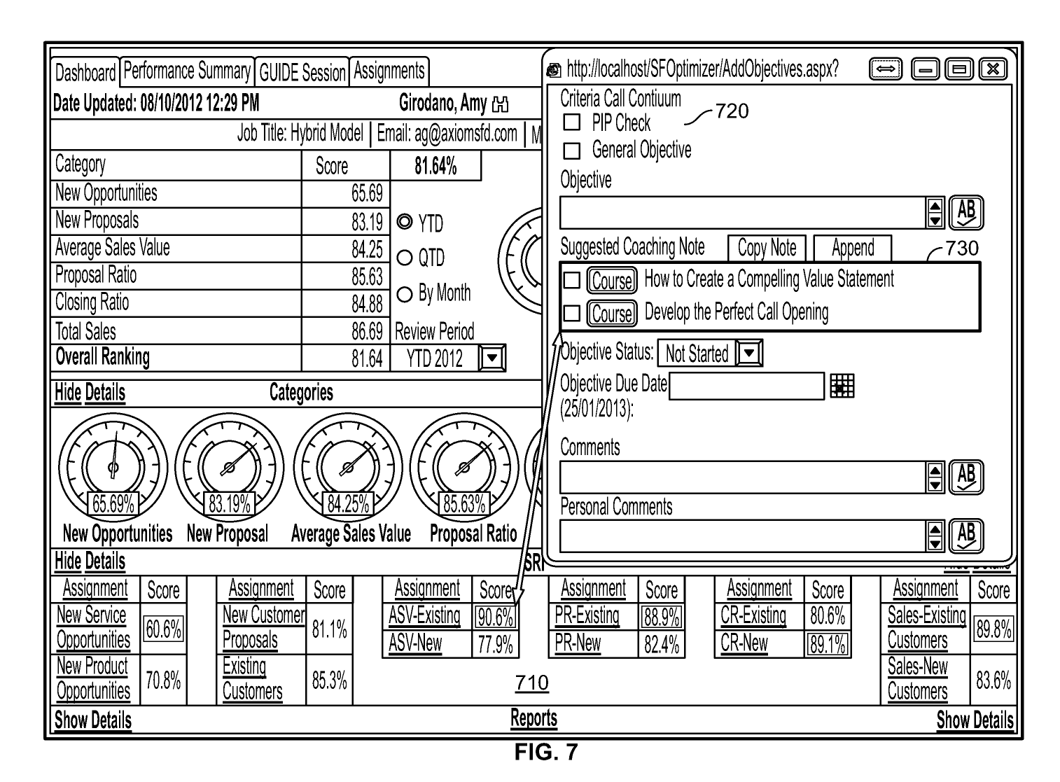

FIG. 7 shows how a user may select a course from a plurality of course offerings made available. First, a performance gap 710 is identified in the coaching solution. Next, a development objective or assignment 720 is formulated based on the identified performance gap 710. Finally, a user may select a course to complete from the list of course offerings 730.

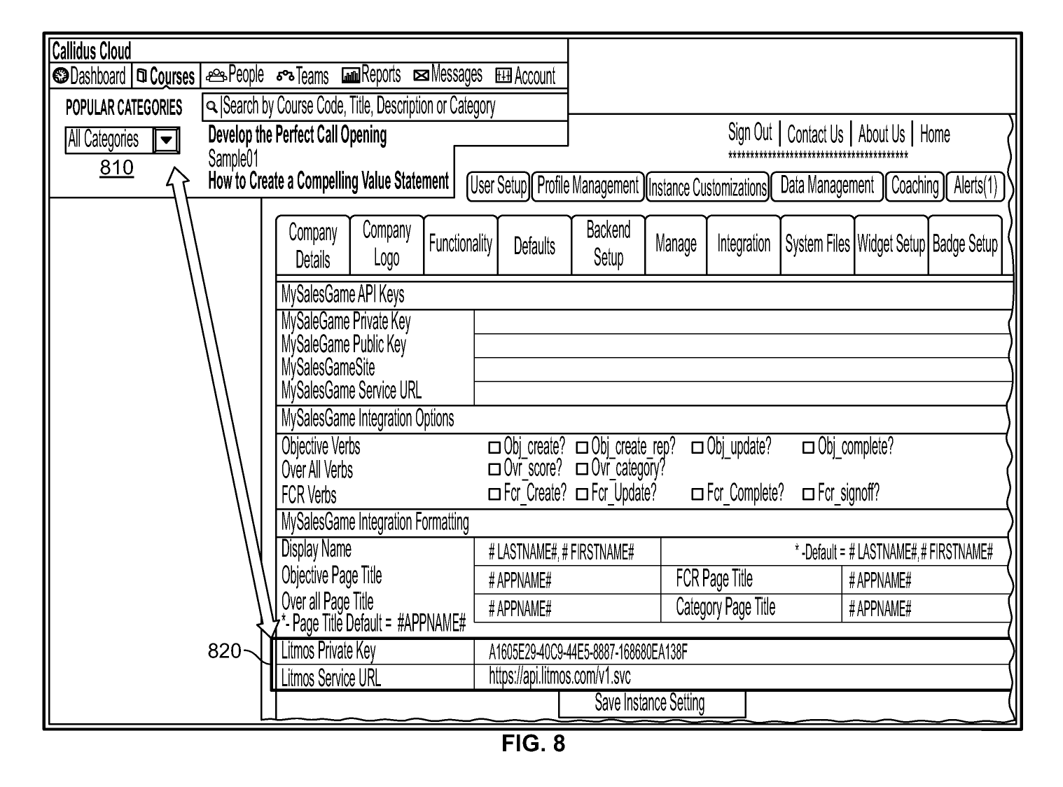

Additionally, the hyperlinking to the assigned courses would include courses that are part of the system and courses that are outside the system. For example some of the hyperlinks that may be directed to courses are developed in-house and for the particular salesperson role. Other courses could be more generic courses that are commercially available and being offered as part of a package as part of the application. For example, in FIG. 8, Litmos® Learning Management System is one such system that may be integrated into the coaching. In 810, courses are developed and configured within the Litmos® system. Litmos® has an Application Program Interface that permits secure access to the coaching system. The subject coaching system has an integration configuration option 820 that allows companies to input its own private key generated by Litmos®.

In addition, there are many commercially available courses by well-known experts in the field that are being charged significant revenue for the hyperlinking with a salesperson's skillset provides a way of commercially marketing of these courses to a target audience. Further, the hyperlinking to the assessment application also provides a convenient way of billing within the company who subscribes to the assessment application can be charged directly through the pre-set up billing system with the company. With billing, an approval system could be set up internally with a company's Human Resources department and managers so that all courses could be pre-approved for taking by employees eliminating the need for the constant reviews of courses that an employee wants to take.

Further, because of this nexus directly with salespersons that need a course for their educational and professional development, the present invention enables the provider to directly negotiate with the courses providers to negotiate as an example revenue-sharing models, or discounted rates or packages together with the sales assessment hyperlinking tools. In addition, many corporations offer educational allowances or stipends to their employees, such education courses when subscribed to can be directly tied to employee accounts and deducted from the employee accounts or a matching system could be set up with company and employee accounts. In addition, depending on the importance or value of a course, the set up with the employee account could allow for the company to partially pay the course amount, (pay 1%, . . . 100%) or even offer an on-the-spot bonus on completion of a course.

The hyperlinking via the assessment application of the present invention also provides for the ability of the provider of the courses to offer different versions of the course. For example for a particular sales skill that is needed for development, the course developer may have a stripped-down or only a portion of the course that needs to be reviewed by the salesperson. Hence, the present invention provides a way that particular skill sets can be targeted with particular course development information from longer and more in-depth courses without the additional necessary time being suspended by the salesperson to show improvement. Also this feature would allow course providers to provide pretrial motions or smaller versions of the courses in the hopes that the target audience would subscribe to the more complete versions thereby enabling the course providers themselves to gain additional review by simply providing a shorter version for preview version of the course.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law. While the invention has been described in connection with certain preferred embodiments, other embodiments may be understood by those of ordinary skill in the art and are encompassed herein.

What is claimed as new and desired to be protected by Letters Patent of the United States is:

1. A method and apparatus for improving a set of tasks performed by a salesperson, comprising:
receiving information about competencies being performed by a salesperson in order to complete a sales transaction wherein each of the competencies associated with salesperson being given a quantitative value;
identifying using an assessment application those tasks being performed by said salesperson to support said competencies and assigning an individual value to said tasks in a manner to affect the quantitative value of the competencies;
using said assessment application to analyze the competencies grouping said competencies into categories needing and not needing improvement, and
generating suggestion requests to said salesperson wherein said suggestion requests being hyperlinks to e-learning tools assigned quantitative values by said assessment application to affect the quantitative value of the competencies depending on a result of completion or not completion of said suggestion requests.

2. The method of claim 1, comprising:
wherein the received information about the competencies being a qualitative score assigned to a salesperson and executing an assessment application associating the tasks with categories and subsequently associating the categories with e-learning tools to generate additional requests to the salesperson.

3. The method of claim 1, comprising:
wherein the e-learning tools being online courses that are grouped in categories to facilitate the assessment application to determine an appropriate course with each request to the salesperson.

4. The method of claim 3, comprising:
using analytics couple to the assessment application to inform the salesperson of the status of completion of an online course and changes in competencies value.

5. The method of claim 4, comprising:
informing an administrator of the status of the completion of an online course.

6. The method of claim 1, comprising:
wherein the suggestion requests of the assessment application being modifiable to add additional assignment information other than using the e-learning tools.

7. The method of claim 5, comprising:
wherein the suggestion requests further comprising assignment histories, rating information, general observations and performance review items.

8. The method of claim 6, comprising:
wherein the assessment application capable of determining quantitative value changes to the competencies of the salesperson when the additional assignment information being completed other than using the e-learning tools.

9. A computer readable medium containing programming instructions for improving a set of tasks performed by a salesperson, the instructions being executable for:
receiving information about competencies being performed by a salesperson in order to complete a sales transaction wherein each of the competencies associated with salesperson being given a quantitative value;
identifying using an assessment application those tasks being performed by said salesperson to support said competencies and assigning an individual value to said tasks in a manner to affect the quantitative value of the competencies;
using said assessment application to analyze the competencies grouping said competencies into categories needing and not needing improvement; and
generating suggestion requests to said salesperson wherein said suggestion requests being hyperlinks to e-learning tools assigned quantitative values by said assessment application to affect the quantitative value of the competencies depending on a result of completion or not completion of said suggestion requests.

10. The computer readable medium of claim 9 further comprising instructions for:
wherein the received information about the competencies being a qualitative score assigned to a salesperson and executing an assessment application associating the tasks with categories and subsequently associating the categories with e-learning tools to generate additional requests to the salesperson,

11. The computer readable medium of claim 9, further comprising instructions for:
wherein the e-learning tools being online courses that are grouped in categories to facilitate the assessment application to determine an appropriate course with each request to the salesperson,

12. The computer readable medium of claim 9, further comprising instructions for:
using analytics coupled to the assessment application to inform the salesperson of the status of completion of an online course and changes in competencies value.

13. The computer readable medium of claim 12, further comprising instructions for:
wherein an administrator is informed of the stats of completion of an online course.

14. The computer readable medium of claim 9, further comprising instructions for:
wherein the suggestion requests of the assessment application being modifiable to add additional assignment information other than using the e-learning tools.

15. The computer readable medium of claim 14, further comprising instructions for:
wherein the suggestion requests further comprising assignment histories, rating information, general observations and performance review items.

16. The computer readable medium of claim 14, further comprising instructions for:
wherein the assessment application capable of determining quantitative value changes to the competencies of the salesperson when the additional assignment information being completed other than using the e-learning tools.

17. A system for improving a set of tasks performed by a salesperson, comprising:
a module to receive information about competencies being performed by a salesperson in order to complete a sales transaction wherein each of the competencies associated with salesperson being given a quantitative value;
an assessment processor coupled to said module for identifying those tasks being performed by said salesperson to support said competencies and to assign an individual value to said tasks in a manner to affect the quantitative value of the competencies, said assessment processor used to analyze the competencies grouping said competencies into categories needing and not needing improvement, and generating suggestion requests to said salesperson wherein said suggestion requests being hyperlinks to e-learning tools assigned quantitative values by said assessment processor to affect the quantitative value of the competencies depending on a result of completion or not completion of the suggestion requests.

18. The system of claim 17, comprising:
wherein the assessment processor associating the tasks with categories and subsequently associating the categories with e-learning tools to generate additional requests to the salesperson.

19. The system of claim 17, comprising:
wherein the e-learning tools being online courses that are grouped in categories to facilitate the assessment processor to determine an appropriate course with each request to the salesperson.

20. The system of claim 19, comprising:
an analytics engine coupled said assessment processor to inform the salesperson of the status of completion of an online course and changes in competencies value.

21. The system of claim 20, comprising:
a notification sent to an administrator which indicates the status of the completion of an online course.

22. The system of claim 17, comprising:
wherein the suggestion requests of the assessment processor being modifiable to add additional assignment information other than using the e-learning tools.

23. The system of claim 21, comprising:
wherein the suggestion requests further comprising assignment histories, rating information, general observations and performance review items.

24. The system of claim 21, comprising:
wherein the assessment processor capable of determining quantitative value changes to the competencies of the salesperson when the additional assignment information being completed other than using the e-learning tools.

25. A method and apparatus for improving a set of tasks performed by a salesperson, comprising:
receiving a competency score about a salesperson, the competency scoring being an aggregation of the competencies being performed by a salesperson in order to complete a sales transaction wherein each of the competencies being given a quantitative value;
identifying using an assessment application those tasks being performed by said salesperson to support said competencies and assigning an individual value to said tasks in a manner to affect the quantitative value of the competencies,
using said assessment application to analyze the competencies grouping said competencies into categories needing and not needing improvement,
generating suggestion requests to said salesperson wherein said suggestion requests being hyperlinks to e-learning tools assigned quantitative values by said assessment application to affect the quantitative value of the competencies depending on a result of completion or not completion of said suggestion requests, and
using a mathematical function to aggregate the competency values to affect the competency score.

26. A method and apparatus for generating revenue by linking the tasks performed by a salesperson to e-learning courses, comprising:
determining using a sales coaching application an e-learning course for a salesperson to enhance a skillset of a salesperson in the performance of a sales transaction,
assigning using an assignment application coupled to the sales coaching application an e-learning course to a salesperson wherein the assigned course being part of the a list of courses pre-hyperlinked to a skillset associated with the completion of a sales transaction, and
negotiating with third party providers of the courses to generate billing and revenue sharing plans coupled to the sales coaching application to enable direct billing and revenue generation of the assigned e-learning courses.
